(19) United States
(12) Patent Application Publication
(10) Pub. No.: US 2014/0183290 A1
(43) Pub. Date: Jul. 3, 2014

(54) Super Pulverizer

(71) Applicant: Hanping Xiao, Saskatoon, CA (US)

(72) Inventor: Hanping Xiao, Saskatoon, CA (US)

(21) Appl. No.: 13/732,386

(22) Filed: Jan. 1, 2013

(51) Int. Cl. B02C 19/06; B02C 23/10; B02C 23/04

(52) U.S. Cl. CPC B02C 19/061; B02C 23/04; B02C 23/10
USPC 241/31; 241/39

(57) ABSTRACT

A mechanical pulverizer adopts multi-stage high-speed rotating turbine and special design structure to achieve ultrafine or nano pulverization. As shown in the figures, the mechanical pulverizer comprises: base plate (1), bearing seats (2 and 3), main shaft (4), motor base (5), main motor (6), casing (7 and 7′), three-stage turbine blisks (8, 9 and 10), multi-surface curved turbine blades (11 and 11′), gear rings with large-angle curved gears (12 and 12′), suspended shearing device (13 and 13′), built-in, unpowered and replaceable grading plates, (14 and 15), feeding inlets (16 and 17), spiral feeder (18), discharge outlet (19), residuals outlet (20), nanometer filter cloth material collecting bin (21), screw rod for casing-opening (22), handle for casing-opening (23), self-pressurized automatic-control liquid nitrogen cooling device (24), and liquid nitrogen conveying pipes (25).

### BACKGROUND OF THE INVENTION

This invention applies to superfine and Nanometer pulverization of all kinds of materials in powder industry, such as all kinds of precious metal, nonmetal mineral substances, plant fiber, industrial chemicals and so on.

It is generally known that the traditional pulverizing machines, such as ball pulverizer, Raymond mill, fan mill, airflow crasher, are functioning by the principles of gravity grind, weight striking or high pressure airflow impacting to acquire superfine powder, they must have independent grading system, induced draft fan system, while airflow pulverizer even needs an independent high pressure gas generation and storage system. The major shortfalls of these traditional pulverizers usually make them poor efficient, high energy consumption, pollution from grinder surface worn residuals, and low level performance in pulverization. In consequence, the high cost on both equipment purchasing and production process impedes them to be largely used in many different fields. Nowadays, most of traditional and similar rotor pulverizers are designed with one stage rotor (single cavity structure). And the rotor adopts connection between unilateral bearing and motor shaft to make up arm support structure. Such kind of structure restrains the possible design of high speed rotation and greater rotor diameter due to its lack of stability in its structure design. As there is only one working cavity, it results in frequent occurrence with low production and poor performance in pulverization.

### SUMMARY OF THE INVENTION

On premise of intensive study on the shortfalls of traditional polverizers, this “Super Pulverizer” takes the aerodynamics principle in its design. It adopts multistage high speed revolution turbine and special design structure to realize the purpose of superfine or nanometer crush from mechanical method. The multistage high speed revolution turbine itself produces multistage strong cyclone and high multiple eddy clash effect to form high pressure cyclone troposphere under the high speed revolution. In high pressure cyclone troposphere, material particle produces strong inertia collision. Different material particles produce mutual transition of motion energy to accelerate material particles' inertia collision movement. It avoids defects of low effect, high energy consumption, pollution from grinder surface worn residual, high production cost, unrealized scale production from traditional pulverizer which are rely on gravity grind, weight striking and independent gradation.

### BRIEF DESCRIPTION OF THE DRAWINGS

FIG. 1 shows the structure of a machine in accordance with an embodiment of the present invention;

FIG. 2 shows the structure inside the casing in accordance with an embodiment of the present invention;

FIG. 3 shows a feeder in accordance with an embodiment of the present invention;

FIG. 4 shows a method of connecting a machine and a collecting bin in accordance with an embodiment of the present invention;

FIG. 5 shows a method of connecting a machine and a liquid nitrogen bottle in accordance with an embodiment of the present invention;

FIG. 6 shows a method of installing a blade on the turbine blisks in accordance with an embodiment of the present invention;

FIG. 7 shows a multi-surface curved blade in accordance with an embodiment of the present invention;

FIG. 8 shows a grading plate and a method of installing it in accordance with an embodiment of the present invention;

FIG. 9 shows a collecting bin in accordance with an embodiment of the present invention;

FIG. 10 shows a residual outlet in accordance with an embodiment of the present invention;

FIG. 10-1 shows a residual outlet in cross section in accordance with an embodiment of the present invention;

FIG. 10-2 shows a residual outlet in cross section in accordance an embodiment of the present invention;

FIG. 11 shows a suspended shearing device in accordance with an embodiment of the present invention;

FIG. 12 shows a large-angle curved gear ring in accordance with an embodiment of the present invention;

FIG. 13 shows a method of installing a shearing device in a gear ring in accordance with an embodiment of the present invention;

FIG. 14 shows a casing horizontally opened in accordance with an embodiment of the present invention;

FIG. 15 shows an automatic discharge system in accordance with an embodiment of the present invention;

FIG. 15-1 shows the automatic discharge system in cross section in accordance with an embodiment of the present invention;

FIG. 16 shows automatic-controlled liquid nitrogen bottle in accordance with an embodiment of the present invention.

### DETAILED DESCRIPTION OF THE PRESENTLY PREFERRED EMBODIMENTS

The pulverizer adopts the integral design of three turbines and three cavities, wherein the left and the right cavities are grinding cavities with residuals discharger. The middle cavity is discharge cavity. Materials enter from the central feeding inlet of the outer sides of the left and the right grinding cavities, after they enter the cavities, they will quickly move towards the cyclone troposphere on the periphery of the grinding cavities under the function of cyclone centrifugal force generated by high speed rotation of the solid turbine. Since the turbine always keeps a certain speed (the rotary speed can be adjusted by frequency converter in accordance with the fineness requirement) of high speed rotation, material particles will do constant free inertial collision and shear motion on the cyclone troposphere layer, and since the difference of the qualities of material particles, kinetic energy will be mutually transformed after collision. When large mass of particles are collided with small mass of particles, large mass of particles keep transmit the large kinetic energy to the small mass of particles to enhance the inertia movement of small mass of particles, in doing so, wanted highly-effective pulverization effect can be obtained. When the mass (particle diameters) of material particles is grinded to required fineness, materials will be automatically discharged to the collecting bin made of the nanometer filtration bin through the internal opening of the grading plate under the function of the wind pressure of turbine fan of the discharge cavity. The material collecting bin and the equipment are connected through pipe and valves. The fineness required can be decided by adjusting the size of the inner opening of the grading plate, adjusting the quantity of the turbine blades of the discharge cavity and adjusting the size of the discharge valve.

The most important advantage of Super pulverizer is that it can get the result of super fine or even nano crushing in a low energy consumption, which the traditional pulverization is unable to reach. The average energy consumption of the Super pulverizer is one third to one fifth, or even lower, of those of the traditional ultra-fine grinding mill finish. So it shall be largely used for the super fine crushing in the field of application. In particular, due to very low energy consumption, it is possible to make the super fine powder to be applied on the large scale of industrialized production in the new energy and clean energy industry. Including:
1. To reduce the cost for the super fine corn straw powder in the industrial production of ethanol
2. To make gasification combustion of the super fine coal powder.
3. To replace coal combustion with the palm shell.
4. To mix and burn with the super fine plants and crops straw and coal powder, etc.
5. Furthermore, it could play even huge positive role in production of food, pharmaceutical, chemical industries, and many other fields

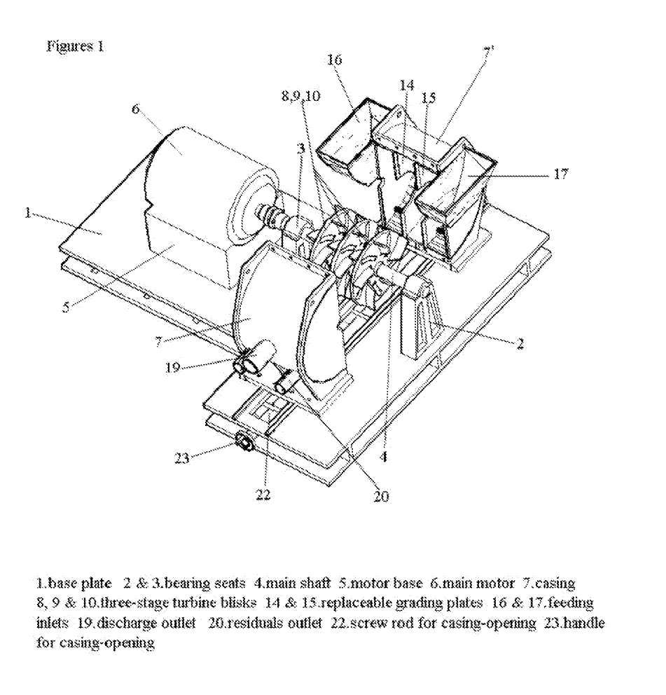

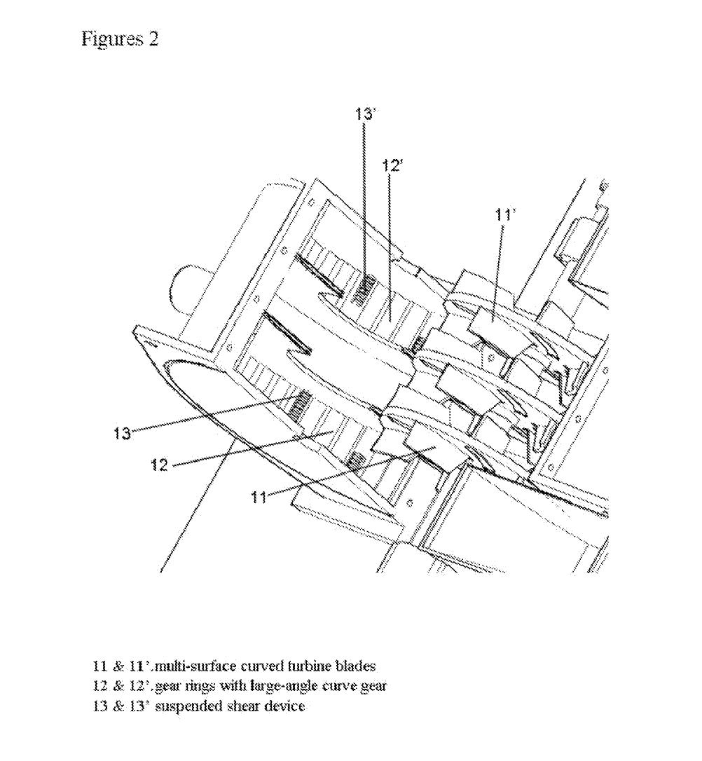

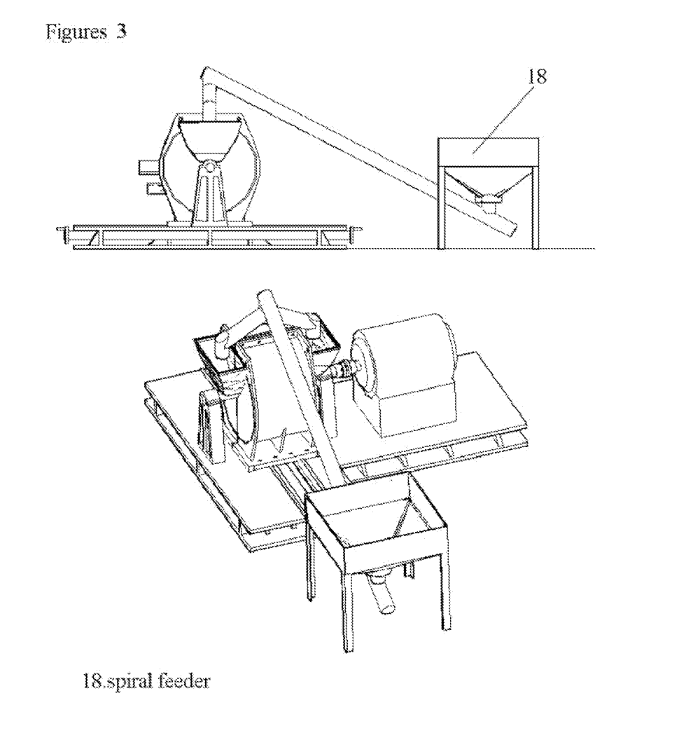

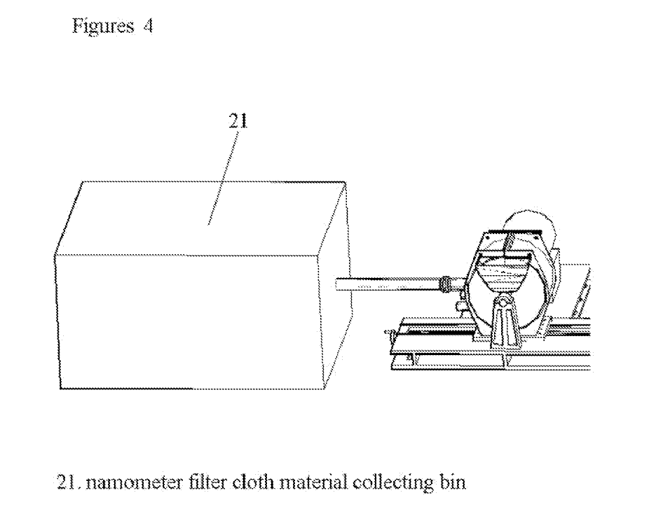

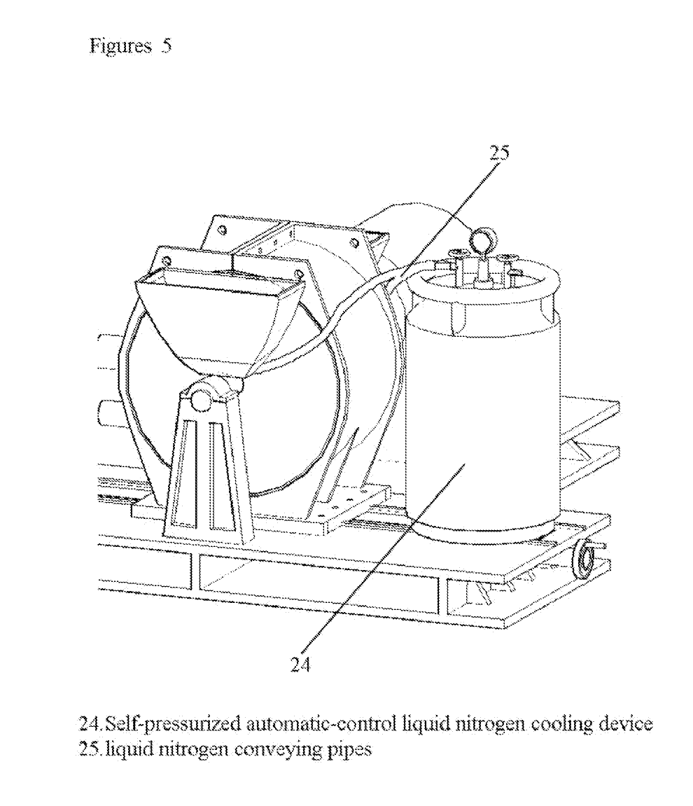

1. A mechanical pulverizer comprising: base plate (1), bearing seats (2 and 3), main shaft (4), motor base (5), main motor (6), casing (7 and 7′), three-stage turbine blisks (8, 9 and 10), multi-surface curved turbine blades (11 and 11′), gear rings with large-angle curved gears (12 and 12′), suspended shearing device (13 and 13′), unpowered and replaceable grading plates, (14 and 15), feeding inlets (16 and 17), spiral feeder (18), discharge outlet (19), residuals outlet (20), nanometer filter cloth material collecting bin (21), screw rod for casing-opening (22), handle for casing-opening (23), self-pressurized automatic-control liquid nitrogen cooling device (24), and liquid nitrogen conveying pipes (25). (see FIGS. 1, 2, 3, 4 and 5).

2. The mechanical pulverizer of claim 1 wherein the cavity is equally divided into three by two built-in, unpowered and steplessly adjustable grading plates with a solid turbine blisk in each cavity. The three blisks are embedded with multi-surface curved blades on both sides. The finished fineness of the material to be pulverized depends on the diameter adjusting of the grading plates and the rotary speed of the machine. The left and right cavities are the grinding areas while the middle cavity is a discharge area. The inner walls of the external circles of the left and right cavities are provided with large-angle curved gear rings, which are lined with a group of suspended shearing devices. The middle cavity is opened with a through hole as the discharge outlet. The pulverizer utilizes high pressure air flow generated by the rotation of the turbine in the middle cavity to deliver the finished powder grinded in the grinding cavities on each sides to the nanometer filter cloth material collecting bin, and the nanometer filter cloth material collecting bin is connected by valve and pipe with the machine. Two residual outlets are opened on the lower part of the casing of the working cavities. All above forms the major pulverization function of this Super pulverizer.
This Super Pulverizer is greatly different from current traditional rotor-type and similar pulverizers. Its originally designed structure not only simplifies all traditional pulverizer by saving the independent powered grading systems and multi-stage steel collecting systems with powered air-induced system, but also exceeds the existing air flow pulverizing technology which depends on high speed air flow provided by an independent air compression system. Currently, most traditional and similar rotor-type pulverizers adopt single-stage rotor, and the rotor is connected with the motor shaft through a one-side bearing. And it forms a single-arm support structure which has poor stability, and restrains the possible application of high speed rotation and the large size rotor. Since there are only one working cavity, the production capability is low, and the pulverization effect remains unsatisfactory. Impingement plate or impingement rod, but not fan blade is mounted on one side of the rotor in most traditional machines. In order to lower weight, the rotor is mostly designed into a hollow structure, but this design can not generate cyclone and cyclone collision, the grinding mechanism is also from the traditional design thought, which realizes the pulverization purpose through colliding materials by bumps like impingement plate or impingement rod mounted on the rotor when the rotor is rotated. However, if these pulverizers shall realize ultra-fine pulverization, they must be provided with independent power grading systems and material collecting systems with induced draft fan systems. It will cause extremely-high equipment production cost, big energy consumption in work, non-ideal pulverization effect and other important problems.

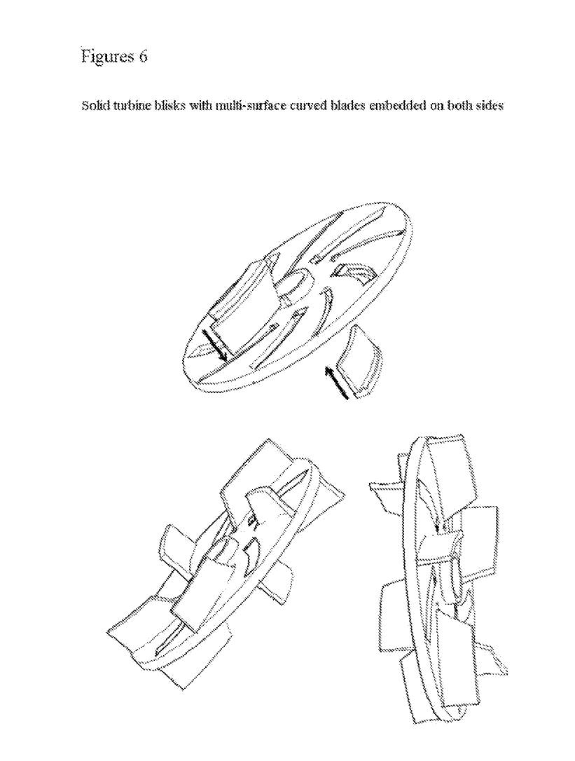

3. The mechanical pulverizer of claim 1 wherein the turbine blisks of the pulverizer adopts the design of solid and double-sided embedded with multi-surface curved turbine blades, it is because that bidirectional cyclone generated by blades on two sides can only gather towards the centrifugal force direction when the blisks are rotated, thereby forming intensive cyclone collision in the outer edge space of the cavity, and forming cyclone troposphere. Through intensive inertia generated by impinging cyclone, materials are mutually collided because of inertia, and therefore, materials are grinded. (See FIG. 6).

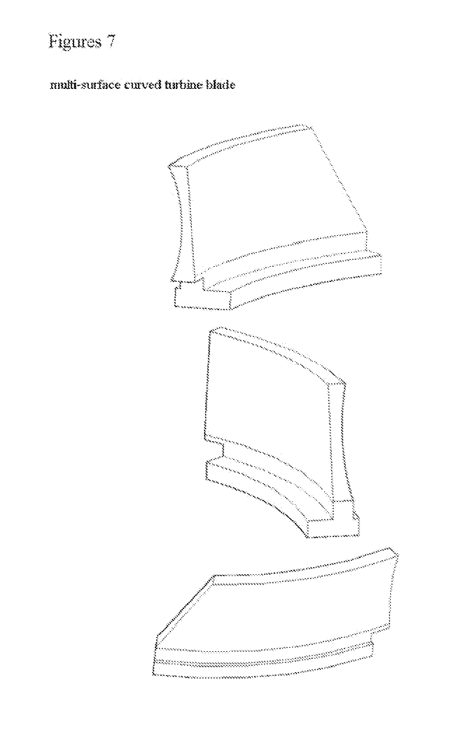

4. The mechanical pulverizer of claim 1 wherein turbine blades adopt a multi-surface curved design to gather air flow, and when the curve blades are rotated at high speed, relatively-closed trajectory is formed, thereby reaching the purpose of always keeping high pressure cyclone collision situation of cyclone troposphere. (See FIG. 7).

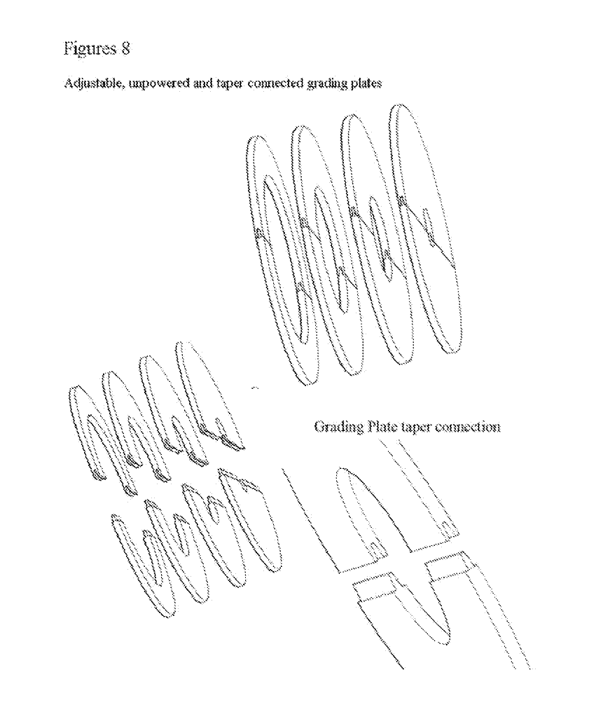

5. The mechanical pulverizer of claim 1 wherein the pulverizer adopts the design of built-in, unpowered and steplessly adjustable grading plates, which makes a breakthrough in existing ultra-fine pulverizers by saving independent grading system, and greatly lowers energy consumption and production cost. Grading plates can be steplessly adjusted by changing their internal opening diameter in accordance with different fineness requirements. The grading plate consists of two semi-circular steel plates which conjoin together tightly by tapered concave-convex design without any fasteners. Two groups of grading plates are embedded in the circular fixing groove on the inner side wall of the casing of the middle discharge cavity, that are actually the partition between the grading cavities and the discharge cavity. (See FIG. 8).

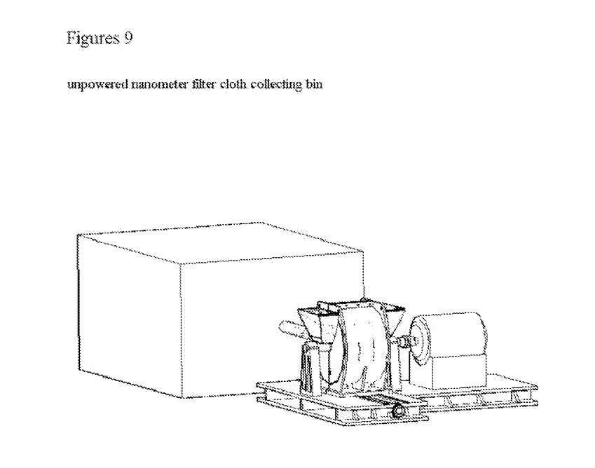

6. The mechanical pulverizer of claim 1 wherein the material collecting part of the pulverizer adopts the design of the metal frame (tent type) nanometer filter cloth material collecting bin, and does not need any power air-induced system. Since the unique design of the pulverizer adopting an automatic discharge manner, it avoids the trouble of majority of traditional pulverizers which adopt multi-stage metal spiral material collecting system and air-induced system. This design achieves the purpose of lowering material cost and reducing energy consumption. (See FIG. 9).

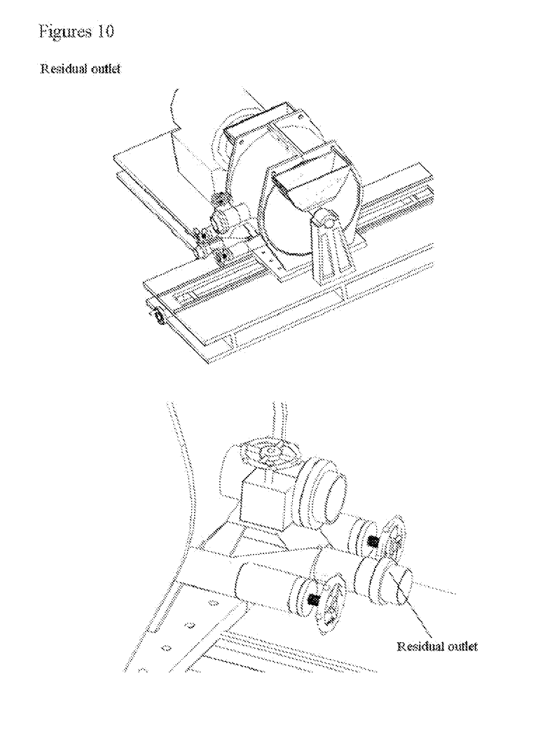

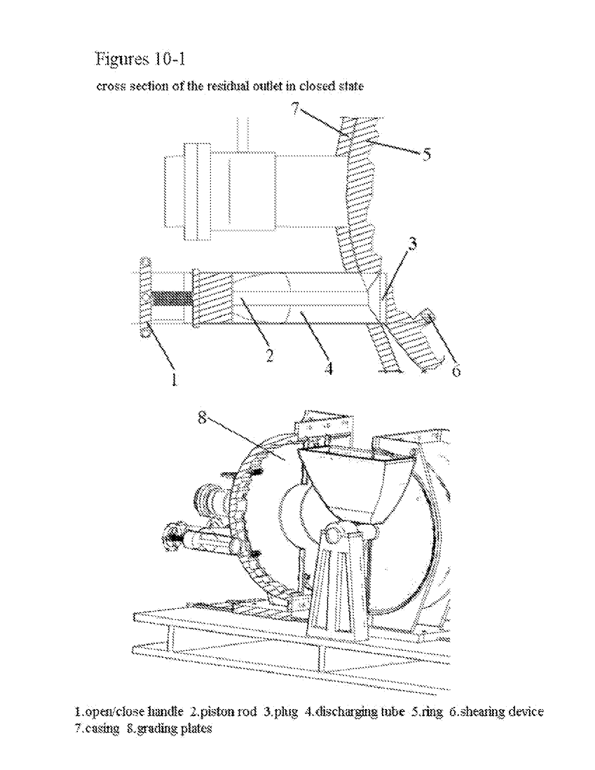

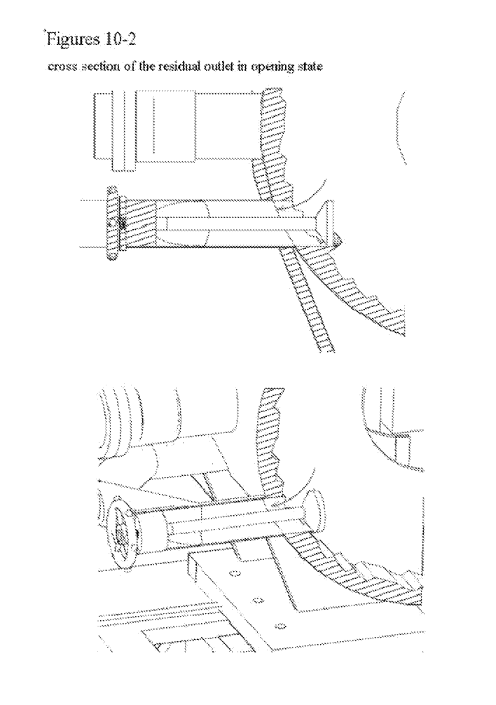

7. The mechanical pulverizer of claim 1 wherein two through holes are opened on the side of grinding cavities casing as the residual outlets. The through holes pass through the gear ring, are externally connected with the piston-type valve, and are used for discharging residuals which is difficult to grind in the grinding cavities without stopping the machine. And therefore, the pulverizer avoids the shortcomings of a traditional pulverizer which must be stopped when discharging residuals, greatly improves working efficiency, and lowers labor cost. (See FIGS. 10, 10-1, 10-2).

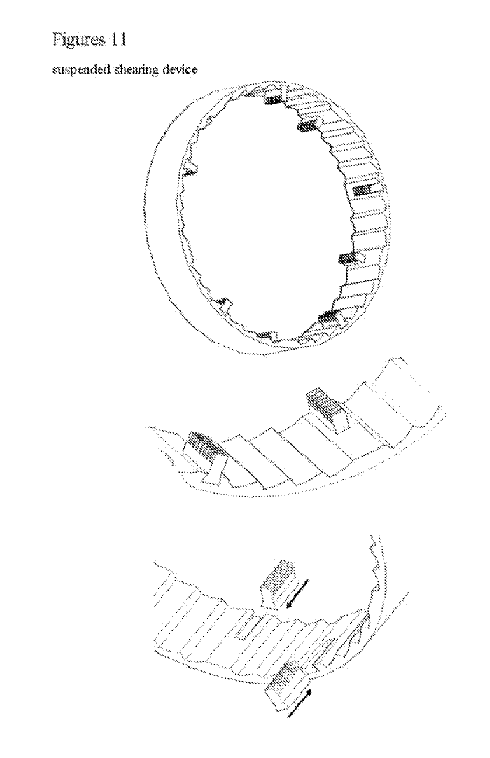

8. The mechanical pulverizer of claim 1 wherein in order to lighten the load of the turbine in rotation, the shearing device is fixed on the gear ring as a stator in a suspending type, so the shortcomings of fixing the blades and the shearing device of the current rotor-type similar pulverizers on the rotor by screws are avoided. Since this structure greatly increases the load of the rotor, the most important problem is that when the rotor is rotated at high speed, due to the heavy load on the rotor, centrifugal force is doubled, and screws are easily fractured by centrifugal force, and therefore, all components in the cavity will be damaged to result in the damage of the equipment. (See FIG. 11).

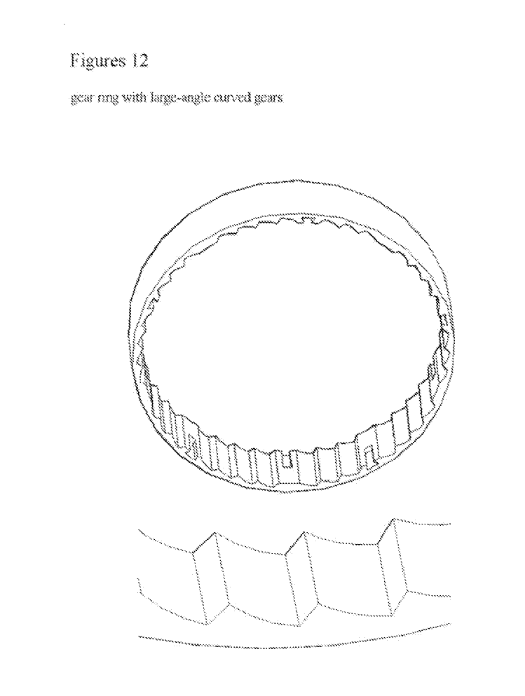

9. The mechanical pulverizer of claim 1 the gear ring adopts the design of the large-angle curved gear for increasing the collision area of material particles firstly. Secondly, the curve design of each gear aims at leading the trajectory of material particles to form rotary motion under the function of concave surface after impinging the gears, thereby generating eddy current. Since there is a certain quantity of same gears on the gear ring, when material particles are collided with the gears on the cyclone troposphere layer, they will generate high-multiple particle eddy locally, thereby enhancing mutual collision and shearing intensity of material particles. And thirdly, the whole gear ring is designed in curved for generating vortex shapes and enhancing the high pressure air flow situation of the cyclone troposphere, thereby reaching the optimum pulverization effect. The whole equipment is provided with two working gear rings which are respectively mounted in the left and the right grinding cavities. (See FIG. 12).

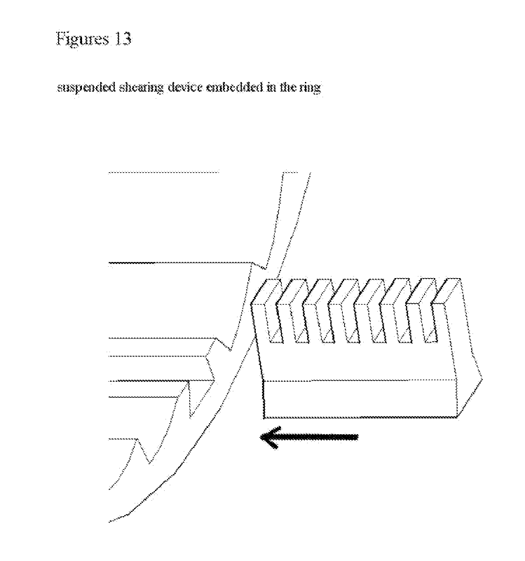

10. The mechanical pulverizer of claim 1 wherein the suspended shearing device adopts the design of being embedded into the gear ring by a ladder shaped bottom of the shearing device and the same shape groove on the ring. And the shearing device is embedded into the gear ring without the fixation by any fasteners. In order to prevent the shearing device from being abraded easily. hard alloy is welded on the heads of the shearing device to improve the wear resistant intensity. (See FIG. 13).

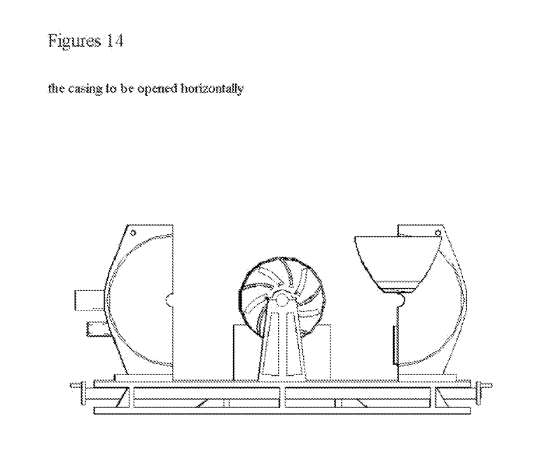

11. The mechanical pulverizer of claim 1 wherein the casing of the machine adopts design of being opened horizontally which saves the lifter when opened for repairing and replacing accessories. While the other similar machine has to be opened vertically by hoisting equipment when repairing and replacing accessories. This horizontal opening design of the Super pulverizer is achieved through mounting tracks and threaded rods on the base plate, and the casing is equally divided and is opened towards the left and the right manually or electrically. (See FIG. 14).

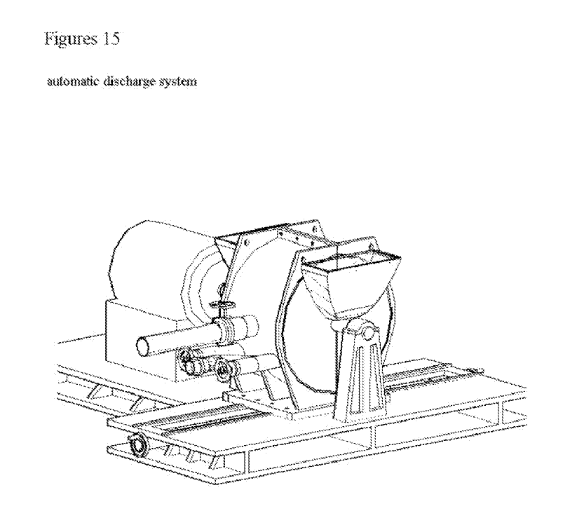

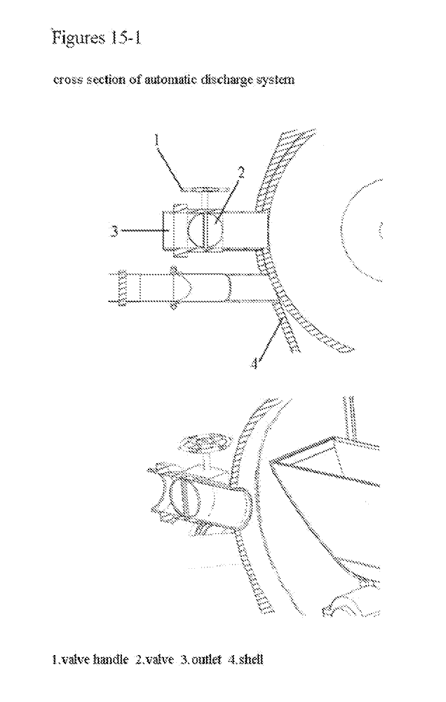

12. The mechanical pulverizer of claim 1 wherein the mechanical pulverizer can discharge the finished powder automatically through the middle cavity, and needs no powered air-inducing system, thereby reaching the purpose of saving energy consumption. On the casing of the middle cavity there is a through hole opened as the outlet on which a valve is mounted and is connected with the collecting bin through pipe. Finished powder will be automatically delivered to the nanometer filter cloth material collecting bin through the conveying pipe by means of wind pressure generated by rotation of the turbine in the middle cavity. The fineness and the yield of powder can be controlled through controlling the throughput of the valve and adjusting the number of the blades on the blisk and the diameters of the grading plates. (See FIGS. 15,15-1).

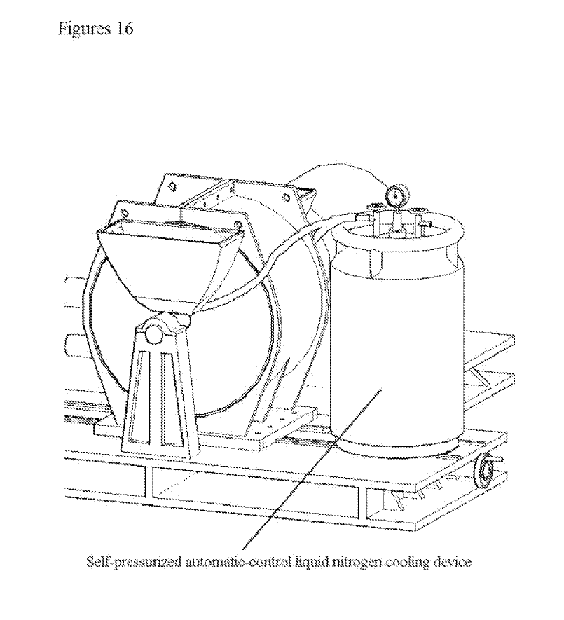

13. The mechanical pulverizer of claim 1 wherein the mechanical pulverizer is equipped with an automatic controlled, adjustable and self-pressurized liquid nitrogen cooling device which can greatly improve cooling effect in work, and effectively prevent the possible dust explosion which may occur when the temperature in the grinding cavity keeps rising. This cooling device makes a tremendous improvement in temperature control in pulverization compared with the traditional pulverizer which usually equipped with a water cooling system that is ineffective in preventing explosion for bad cooling, and has a high production cost, high energy consumption, large equipment volume. (See FIG. 16).
